(19) United States
(12) Patent Application Publication
(10) Pub. No.: US 2015/0302961 A1
(43) Pub. Date: Oct. 22, 2015

(54) FABRICATION METHOD OF RARE EARTH-BASED SINTERED MAGNET

(71) Applicant: KOREA UNIVERSITY RESEARCH AND BUSINESS FOUNDATION, Seoul (KR)

(72) Inventors: Seong Rae LEE, Seoul (KR); Tae Hoon KIM, Seoul (KR); Tae Seok JANG, Seoul (KR)

(21) Appl. No.: 14/683,840

(22) Filed: Apr. 10, 2015

(30) Foreign Application Priority Data
Apr. 18, 2014 (KR) 10-2014-0046847

(51) Int. Cl. H01F 1/057; H01F 7/02; B22F 3/26; B22F 7/02; H01F 41/02; B22F 3/10

(52) U.S. Cl. CPC H01F 1/0577; H01F 41/0253; H01F 41/0293; B22F 3/10; B22F 3/26; B22F 7/02; H01F 7/02; B22F 2003/248

(57) ABSTRACT

Provided is a fabrication method of a rare earth-based sintered magnet including: a) a first doping step of mixing and sintering a first doping material including a first heavy rare earth compound with a rare earth-based magnet raw material powder to fabricate a first doped sintered body; and b) a second doping step of forming a coating layer of a second doping material including a second heavy rare earth compound on a surface of the first doped sintered body and performing a heat-treatment to fabricate a second doped sintered body.

### CROSS-REFERENCE TO RELATED APPLICATIONS

This application claims priority under 35 U.S.C. §119 to Korean Patent Application No. 10-2014-0046847, filed on Apr. 18, 2014, in the Korean Intellectual Property Office, the disclosure of which is incorporated herein by reference in its entirety.

### TECHNICAL FIELD

The following disclosure relates to a fabrication method of a rare earth-based sintered magnet, and more specifically, to a fabrication method of a rare earth-based sintered magnet capable of decreasing usage of a heavy rare earth element and having excellent coercivity.

### BACKGROUND

As compared with a ferrite-based magnet having magnetic energy of 4MGoe, a lanthanide cobalt magnet is 5 times stronger than the ferrite-based magnet and a neodymium-based magnet is 9 times stronger than the ferrite-based magnet. For slimness and lightness, high performance or energy saving of a motor or a generator, the neodymium-based magnet is utilized, in particular, an interest in a rare earth-based magnet as a driving motor of a hybrid car or a hydrogen fuel car has been increased.

Accordingly, as described in Korean Patent Laid-Open Publication No. 2011-0126059, a research into a technology for improving rare earth-based magnetic characteristic by developing a novel alloy composition and a research into a fabrication method capable of increasing coercivity as described in Korean Patent Laid-Open Publication No. 2011-0096104 have been conducted.

Among them, a method of forming a core-shell structure by concentrating some of the heavy rare earth elements around an interface of a crystal grain to thereby increase the coercivity and prevent a decrease in a residual magnetic flux density has been used.

For a doping process, a core-shell fine structure is fabricated by a process of adding a heavy rare earth source as a powder type and performing a heat-treatment or a grain boundary diffusion process using the heavy rare earth source; however, the powder addition process has problems in that a shell to be formed has an excessively thick thickness and when the heavy rare earth source is excessively diffused to the core, it is difficult to perform selectively dope around the interface, and a large amount of the heavy rare earth needs to be added, and the grain boundary diffusion process is capable of concentrating the heavy rare earth source around the interface as compared to the powder addition process, but has problems in that a diffusion depth is limited, it is difficult to obtain homogeneous magnetic characteristic, and only a thin magnet or a small-sized magnet is possible to be fabricated.

### RELATED ART DOCUMENT

### (Patent Document 1) Korean Patent Laid-Open Publication No. 2011-0126059

### (Patent Document 2) Korean Patent Laid-Open Publication No. 2011-0096104

### SUMMARY

An embodiment of the present invention is directed to providing a fabrication method of a rare earth-based sintered magnet capable of decreasing usage of a heavy rare earth element and having excellent magnetic characteristic. Another embodiment of the present invention is directed to providing a fabrication method of a sintered magnet capable of being fabricated in a bulky dimension and having homogeneous magnetic characteristic.

In one general aspect, a fabrication method of a sintered magnet includes:

a) a first doping step of mixing and sintering a first doping material including a first heavy rare earth compound with rare earth-based magnet raw material powder to fabricate a first doped sintered body; and

b) a second doping step of forming a coating layer of a second doping material including a second heavy rare earth compound on a surface of the first doped sintered body and performing a heat-treatment to fabricate a second doped sintered body.

The second doping step may satisfy the following Relational Formula 1 by the first doping step:

L_{dif}⁰≦1.5L_{dif} (Relational Formula 1)

in Relational Formula 1, when performing step b) on a reference sintered body fabricated without mixing the first heavy rare earth compound in step a), L_{dif}⁰ indicates a depth in which the second heavy rare earth compound is diffused in a depth direction perpendicular to a surface of the reference sintered body on which the coating layer is formed, and L_{dif} indicates a depth in which the second heavy rare earth compound is diffused in a depth direction perpendicular to a surface of the first doped sintered body on which the coating layer is formed.

The rare earth-based magnet raw material powder may contain Nd, B and Fe.

The rare earth-based magnet raw material powder may further contain one or two or more metals selected from the group consisting of Cu, Co, Al and Nb.

An ionic radius of a relative element which is a hetero element bound to a first heavy rare earth element contained in the first heavy rare earth compound may be larger than that of boron (B).

The sintered body of step a) may contain 0.5 to 1.5 wt % of a first heavy rare earth element derived from the first heavy rare earth compound.

The first heavy rare earth compound may be a halide.

The second heavy rare earth compound may be a hydride.

A first heavy rare earth element of the first heavy rare earth compound and a second heavy rare earth element of the second heavy rare earth compound may be each independently one or two or more selected from the group consisting of Dy, Tb, Ho, Sm, Gd, Er, Tm, Yb, Lu and Th.

The sintering of step a) may be performed at 1000 to 1100° C.

The heat-treatment of step b) may be a multi-step heat-treatment including a first heat-treatment at 800 to 950° C. and a second heat-treatment at 400 to 600° C.

In another general aspect, there is provided a sintered magnet fabricated by the fabrication method as described above.

### BRIEF DESCRIPTION OF THE DRAWINGS

FIG. 1 is a scanning electron micrograph image (a) obtained by observing a cross section of a sintered magnet fabricated by Example 1, compared to a view (b) illustrating a mapping result of Dy element concentration of the corresponding cross section.

FIG. 2 is a cross section of a reference sintered magnet fabricated by Comparative Example 1 and FIG.

FIG. 3 is a scanning electron micrograph image (a) obtained by observing a fine structure of the sintered magnet fabricated by Example 1 compared to a view (b) illustrating a mapping result of Dy element concentration of the corresponding cross section.

FIG. 4 is a scanning electron micrograph image obtained by observing a fine structure of the sintered magnet fabricated by Comparative Example 3 and is a view illustrating a mapping result of each element concentration by energy spectral analysis.

FIG. 5 is a scanning electron micrograph image obtained by observing a fine structure of the sintered magnet fabricated by Comparative Example 4 and is a view illustrating a mapping result of each element concentration by energy spectral analysis.

FIG. 6 is a view illustrating results obtained by measuring coercivity (FIG. 6a) and remanence (FIG. 6b) of the sintered magnets fabricated by Examples 1 to 4 and Comparative Examples 1 and 2.

FIG. 7 is a view illustrating each permanent magnet performance index of the sintered magnets fabricated by Examples 1 to 4 and Comparative Examples 1 and 2 for each Dy content of the sintered body.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings. The drawings to be described below are provided by way of example so that the idea of the present invention can be sufficiently transferred to those skilled in the art to which the present invention pertains. Therefore, the present invention may be implemented in many different forms, without being limited to the drawings to be described below. The drawings may be exaggerated in order to specify the spirit of the present invention. Here, unless technical and scientific terms used herein are defined otherwise, they have meanings understood by those skilled in the art to which the present invention pertains. Known functions and components which obscure the description and the accompanying drawings of the present invention with unnecessary detail will be omitted.

Doping of a heavy rare earth element has been used in order to increase coercivity of a rare earth-based sintered magnet. However, the heavy rare earth element is very expensive due to significantly small reserves, which is a major obstacle in commercializing the rare earth-based sintered magnet.

As a result obtained by research into a fabrication method of a rare earth-based sintered magnet capable of minimizing usage of the high-priced heavy rare earth element, having excellent magnetic characteristic, and improving productivity, the present applicant found that a sintered body having excellent magnetic characteristic and homogeneous magnetic characteristic is capable of being fabricated even with only using a small amount of heavy rare earth element by controlling diffusion characteristics of doping elements through a multi-step doping process, and filed the present invention.

In the fabrication method according to an exemplary embodiment of the present invention, the sintered magnet may be a rare earth-based sintered magnet, the rare earth-based sintered magnet being an Nd—Fe—B-based sintered magnet. The rare earth-based magnet raw material powder may contain Nd, Fe and B, and may further contain at least one transition element (M) selected from Cu, Co, Al and Nb in order to improve required characteristics such as corrosion resistance, and the like. Here, the rare earth-based magnet raw material powder may include a base material powder of the rare earth-based sintered magnet.

Specifically, the rare earth-based magnet raw material powder may contain Nd, Fe and B so that a main phase (base material) formed by sintering magnet raw material powder satisfies NdₓFe_{y}B_{z} (x is a real number of 1.5 to 2.5, y is a real number of 13.5 to 14.5, and z is a real number of 0.95 to 1.1). Here, as described above, when the magnet raw material powder further contains the transition element (M), the transition element (M) may be some substituted Fe contained in the magnet raw material powder, and specifically, the magnet raw material powder may further contain the transition element (M) corresponding 2.0 to 3.0 atom % of Fe based on total weight (100 atom %) of Fe contained in the magnet raw material powder.

The fabrication method of a rare earth sintered magnet according to an exemplary embodiment of the present invention may include: a) a first doping step of mixing and sintering a first doping material including a first heavy rare earth compound with rare earth-based magnet raw material powder to fabricate a first doped sintered body; and b) a second doping step of forming a coating layer of a second doping material including a second heavy rare earth compound on a surface of the first doped sintered body and performing a heat-treatment to fabricate a second doped sintered body.

That is, the fabrication method according to an exemplary embodiment may include a multi-step doping process consisting of the first doping step of mixing a first doping material with magnet raw material powder and performing a heat-treatment, and the second doping step of forming a coating layer of the second doping material on the surface of the first doped sintered body, followed by diffusion of the second doping material from the coating layer to the sintered body, to thereby fabricate the sintered magnet.

By the multi-step doping process, the usage of the heavy rare earth element used as the doping material may be decreased and formation of an undesired abnormality such as a heavy rare earth oxide in the sintered magnet may be prevented, and diffusion of the second doping material in the second doping step may be promoted, such that an output of the sintered magnet having uniform magnetism may be improved.

In general, it is known that it is more preferred to prevent a lattice diffusion or bulk diffusion which is a diffusion through an inside of the crystal at the time of doping the heavy rare earth element, in order to fabricate a core-shell structure including a crystal grain core of a main phase and a shell enclosing the crystal grain core and including a large amount of doped heavy rare earth element.

However, rather, when stress, point defects, or the like, is generated in the main phase by the lattice diffusion of the first doping material with respect to the main phase during the first doping step, and then the second doping using the surface coating layer is performed based on the above-described multi-step doping process, grain boundary diffusion of the second doping material may be remarkably improved.

In detail, in the fabrication method according to an exemplary embodiment of the present invention, the second doping step may satisfy the following Relational Formula 1 by the first doping step:

L_{dif}⁰≦1.5L_{dif} (Relational Formula 1)

in Relational Formula 1, when performing step b) on a reference sintered body fabricated without mixing the first heavy rare earth compound in step a), L_{dif}⁰ indicates a depth in which the second heavy rare earth compound is diffused in a depth direction perpendicular to a surface of the reference sintered body on which the coating layer is formed, and L_{dif} indicates a depth in which the second heavy rare earth compound is diffused in a depth direction perpendicular to a surface of the first doped sintered body on which the coating layer is formed.

More specifically, in the first doping step, the stress and the defects may be formed in the main phase formed by sintering the rare earth-based magnet raw material powder from the first heavy rare earth compound as well as doping by the first heavy rare earth compound. Due to the formation of the stress and the defects, the diffusion of the second doping step may be promoted, and the doping in the second doping step may satisfy the above-described Relational Formula 1.

In the second doping step, the coating layer may serve as a material source supplying a doping element on a surface of a doping target, and by heat-treating the doping target on which the coating layer is formed, the doping element contained in the coating layer may be diffused in the doping target, thereby performing a doping process.

In detail, in a case of performing the multi-step doping process according to an exemplary embodiment of the present invention, as compared to a reference diffusion depth (L_{dif}⁰) which is a diffusion depth of the second heavy rare earth compound when a reference sintered body is fabricated by sintering the rare earth-based magnet raw material powder without adding the first heavy rare earth compound, the coating layer of the second doping material including the second heavy rare earth compound is formed on the surface of the reference sintered body, followed by heat-treatment, when the first doping step is performed and the second doping step is performed, the diffusion of the second heavy rare earth compound may be achieved at a depth 1.5 times or more the reference diffusion depth, specifically, up to a depth 2.0 times or more, Here, the diffusion depth indicates a depth at which at least 1.0 element % or more of the doping element is detected in an analysis of an element content depending on the depth (depth profile) by an EPMA (Electron Probe Micro Analyzer) with WDS (Wavelength Dispersive Spectroscopy). Here, in an exemplary embodiment of the present invention in which the first doping step and the second doping step are sequentially performed, when the heavy rare earth elements doped in the first doping step and the second doping step are the same as each other, the diffusion depth indicates a depth in which the doping element is detected in 1.0 element % or more as compared to a reference (0%), the reference being defined as a detection concentration of the doping element in the first doping step.

In step a), in order to prevent formation the undesired abnormality such as the heavy rare earth oxide, and perform the doping (first doping) of the heavy rare earth element and effectively form the defects and the stress (including lattice distortion) in the main phase by the heavy rare earth compound, it is preferred to mainly control a material of the first heavy rare earth compound, and an amount and a sintering temperature of the first heavy rare earth compound.

In order to more effectively form the defects and the stress in the main phase, preferably, an ionic radius of a relative element which is a hetero element bound to the first heavy rare earth element contained in the first heavy rare earth compound may be larger than that of boron (B). In addition, the first heavy rare earth compound may preferably be a material in which the lattice diffusion to the main phase is easily performed. Accordingly, the first heavy rare earth compound may be a halide. The halide may be one selected from chloride, fluoride, bromide, and iodide, when a difference in an ionic radius between the relative element and boron (B) is excessively small, formation of the stress including the lattice distortion may not be sufficient, and when the difference in an ionic radius between the relative element and boron (B) is excessively large, the lattice diffusion may not be easily generated. In this regard, the first heavy rare earth compound is most preferably a fluoride.

In addition, when the first heavy rare earth compound is a halide, preferably, a fluoride, density (relative density) of the sintered body (the first doped sintered body) obtained in step a) may be decreased, and due to the decreased relative density and the subsequent doping process of step b), the diffusion of the second doping material in the second doping step may be promoted. Specifically, the relative density of the first doped sintered body may be 96.5 to 97.5(%), and accordingly, the second doping step satisfying Relational Formula 1, specifically, Relational Formula 1-1 may be performed:

L_{dif}⁰≦2L_{dif} (Relational Formula 1-1)

in Relational Formula 1-1, when performing step b) on the sintered body (the reference sintered body) fabricated without mixing the first heavy rare earth compound in step a), L_{dif}⁰ indicates a depth in which the second heavy rare earth compound is diffused in a depth direction perpendicular to a surface on which the coating layer is formed, and L_{dif} indicates a depth in which the second heavy rare earth compound is diffused in a depth direction perpendicular to a surface of the first doped sintered body on which the coating layer is formed.

In addition, when the first heavy rare earth compound is a halide, preferably, a fluoride, even though the abnormality remains in the sintered body after the sintering of step a), the abnormality may not be an oxide of the first heavy rare earth element, but may be a rare earth-oxygen-halogen compound contained in the magnet raw material powder, which does not function as a sink of the heavy rare earth element unlike the oxide, such that the shell having significantly uniform thickness may be formed by the first and second doping processes.

The first heavy rare earth element of the first heavy rare earth compound may be one or two or more selected from the group consisting of Dy, Tb, Ho, Sm, Gd, Er, Tm, Yb, Lu and Th. As non-limiting examples thereof, when the sintered magnet to be fabricated is Nd—Fe—B-based material, the first heavy rare earth element may be preferably Dy, Tb or Dy and Tb, in order to improve magnetic characteristic.

The defects generated in the main phase by the first heavy rare earth compound may include a vacancy defect, an interstitial defect and/or a substitutional defect, and the stress generated in the main phase may include lattice distortion. As an example thereof, when the hetero element having different ionic radius (the element derived from the first heavy rare earth compound) is positioned in the lattice, due to the difference in the ionic radius, lattice distortion may be generated in the main phase.

The amount of the first heavy rare earth compound in the first doping step may be an amount which allows the first doped sintered body to contain the first heavy rare earth element (the first heavy rare earth element derived from the first heavy rare earth compound) of 0.5 to 6.5 wt %, preferably, 0.5 to 1.5 wt %. The amount of the first heavy rare earth compound may be a small amount so that a non-reacted (or non-diffused) state of the first heavy rare earth compound to be put as raw material rarely remains at the time of performing the sintering process, but generates the defects and stress in the main phase. That is, the amount may be an amount in which the non-reacted (or non-diffused) first heavy rare earth compound does not remain at the time of performing the sintering process while generating the defects and the stress in the main phase, and the first heavy rare earth oxide is not generated by the non-reacted first heavy rare earth compound.

The sintering temperature of step a) may be preferably 1000 to 1100° C., and in general, the grain boundary diffusion has a relatively low diffusion energy barrier as compared to the lattice diffusion. Accordingly, by controlling the sintering temperature of step a) to be 1000 to 1100° C., thermal energy enough to easily exceed the diffusion energy barrier required for the lattice diffusion may be provided, a ratio of the lattice diffusion as compared to the grain boundary diffusion may be more improved, and a large amount of vacancy defects may be generated.

In the fabrication method according to an exemplary embodiment of the present invention, the first doping process in step a) may include i) a step of mixing the first doping material including the first heavy rare earth compound with the rare earth-based magnet raw material powder; ii) a step of fabricating a molding body by compression-molding the mixture of step i); and iii) fabricating the first doped sintered body by sintering the molding body.

The mixing step i) may be a dry mixing process, and may be any mixing process generally used in uniformly and homogeneously mixing powders. An average grain size of the powder (including the first doping material powder and the magnet raw material powder) used as the raw material may have a range of 1 to 10 μm so as to provide enough driving force for grain growth and densification at the time of sintering, and generate the uniform and homogeneous reaction between the raw materials. Here, the rare earth-based magnet raw material powder may be each raw material (element) powder of the rare earth-based magnet to be fabricated, each raw material compound (element compound) powder of the rare earth-based magnet to be fabricated, powder of compounds among the rare earth-based magnet raw materials (compound among elements) to be fabricated, and powder of the rare earth-based magnet (base material) itself to be fabricated. As non-limiting examples thereof, the rare earth-based magnet raw material powder may be a powder containing the transition element (M) corresponding 2.0 to 3.0 atom % of Fe based on total weight (100 atom %) of Fe contained in NdₓFe_{y}B_{z} (x is a real number of 1.5 to 2.5, y is a real number of 13.5 to 14.5, and z is a real number of 0.95 to 1.1) powder, or NdₓFe_{y}B_{z} (x is a real number of 1.5 to 2.5, y is a real number of 13.5 to 14.5, z is a real number of 0.95 to 1.1) powder.

The molding body of step ii) may be fabricated by putting the mixture of step i) into a mold (a molding frame) and compression-molding the mixture under a pressure of 200 to 400 MPa. The molding body may have a shape appropriate for uses of the sintered magnet, and is not limited in view of a shape. For example, the molding body may have a hexahedral shape (cube or rectangular parallelepiped) or a disk shape which is favorable to form a uniform coating layer since after the first doping step, the coating layer is formed on the surface of the first doped sintered body and heat-treatment is performed. However, the present invention is not limited in view of a shape of the molding body. In addition, according to an exemplary embodiment of the present invention, the multi-step doping process consisting of the first doping step and the second doping step may be performed, such that the second doping satisfying the above-described Relational Formula 1 may be achieved. Accordingly, even though a thick molding body is fabricated, the doping may be uniformly and homogeneously achieved. As a specific example, in a case of general dip-coating method, a diffusion distance of the doping material is known to be about 300 μm, but in the fabrication method according to an exemplary embodiment of the present invention, the diffusion distance of the doping material in the second doping step may be 450 μm or more, or 700 μm or more. Therefore, when the doping material is diffused from two surfaces facing each other of the first doped sintered body, even in a case of fabricating the molding body and the first sintered body so as to have a thickness (a distance between the two surfaces facing each other) of 0.9 mm or more, or 1.4 mm or more, a sintered magnet having stable and homogeneous magnetic characteristic may be fabricated.

The sintering of step iii) may be performed in a vacuum atmosphere or an inert atmosphere. Here, the vacuum atmosphere may be a pressure of 1×10⁻⁴ to 1×10⁻⁷ torr, and the inert atmosphere may be argon, nitrogen, helium or a mixed gas thereof. Time required for the sintering process (hereinafter, referred to as a sintering time) is enough to perform nucleation and growth of the main phase by the rare earth-based magnet raw material powder and perform sufficient densification. As non-limiting examples thereof, the sintering time may be 1 to 4 hours.

As described above, through the first doping step, the main phase may be doped with the first heavy rare earth element derived from the first heavy rare earth compound, and simultaneously, the first doped sintered body in which the stress including the lattice distortion and the defects are formed may be fabricated. The first doped sintered body may be doped again by the second doping step. The second doping step may be a process of forming the coating layer which is a material source of the second doping material on the surface of the first doped sintered body and then diffusing the second doping material from the surface of the sintered body to the inside of the sintered body, that is, a grain boundary diffusion process.

In detail, the second doping step may include 1) a step of forming the coating layer of the second doping material on the surface of the first doped sintered body using a doping liquid containing the second doping material including the second heavy rare earth compound; and 2) a step of heat-treating the first doped sintered body on which the coating layer is formed to diffuse (drive-in) the second doping material in the first doped sintered body.

The stress and the defects generated in the main phase by the first doping step may remarkably promote the grain boundary diffusion of the second doping material. In detail, as described in Relational Formula 1, the second doping material may be diffused at a depth 1.5 times or more, more specifically, 2 times or more as compared to the reference sintered body.

In addition, the heavy rare earth element is doped on the main phase using the multi-step doping process and a small amount of the first heavy rare earth compound is added in the first doping step, thereby preventing formation of undesired abnormality hindering the core-shell structure such as an oxide. Therefore, at the time of forming the core-shell structure including the core of the main phase and the shell in which a large amount of the heavy rare earth element (including the first heavy rare earth element derived from the first heavy rare earth compound and the second heavy rare earth element derived from the second heavy rare earth compound) is doped on the main phase by the second doping step, a shell having a uniform and thin thickness and entirely enclosing the core may be formed. That is, in the first doping step, the small amount of the first heavy rare earth compound is added to allow formation of the defects and the stress promoting the grain boundary diffusion in the main phase, such that more uniform and homogenous core-shell structure may be formed in the same treatment condition of the second doping step, and in the second doping step, the diffusion depth may be remarkably improved and simultaneously, the doping may be significantly homogeneously performed, and therefore, the magnetic characteristic and the output of the sintered magnet may be remarkably improved.

In the second doping step, the coating layer may be formed by spraying and drying the doping liquid in the first doped sintered body or by immersing the first doped sintered body in the doping liquid and recovering and drying the second doped sintered body. Here, the coating layer of the second doping material may be formed in an entire surface region of the first doped sintered body. The doping liquid may contain the second doping material and a solvent, wherein the solvent may be any material as long as it dissolves the second doping material and it does not chemically react with the first doped sintered body but is stable. As a specific example thereof, the solvent of the doping liquid may be a lower C1 to C3 alcohol, and the like. However, the present invention is not limited in view of the solvent of the doping liquid. A concentration of the second doping material in the doping liquid is enough as long as the formed coating layer is capable of sufficiently supplying the second doping material in the first doped sintered body. As a specific example thereof, the doping liquid may contain 20 to 80 M (molar concentration) of the second doping material. The drying process is not specifically limited, but may be performed under an inert air or a vacuum atmosphere (1×10⁻¹ to 1×10⁻³ torr) and at a temperature of 50 to 100° C.

The second doping material may include the second heavy rare earth compound, and the second heavy rare earth compound is preferably a hydride capable of being diffused in the first doped sintered body mainly through the grain boundary diffusion. The second heavy rare earth element of the second heavy rare earth compound may be one or two or more of element(s) selected from the group consisting of Dy, Tb, Ho, Sm, Gd, Er, Tm, Yb, Lu and Th, which is independently from the first heavy rare earth compound. As a non-limiting example thereof, when the sintered magnet to be fabricated is Nd—Fe—B-based material, the second heavy rare earth element is preferably Dy, Tb or Dy and Tb, in order to improve magnetic characteristic, and more preferably, the second heavy rare earth element is the same as the first heavy rare earth element in view of fabrication of the sintered magnet having homogeneous and excellent magnetic characteristic.

After the coating layer is formed in the first doped sintered body, the heat-treatment (drive-in) for diffusing the second doping material from the surface on which the coating layer is formed to the inside of the sintered body may be performed.

The heat-treatment in the second doping step is performed for doping the second doping material mainly with the grain boundary diffusion, and therefore, a temperature of the heat-treatment of the second doping step is preferably a temperature at which the energy barrier required for the lattice diffusion is not excessive but the energy barrier required for the grain boundary diffusion may be easily exceeded. Accordingly, the heat-treatment in the second doping step preferably includes a first heat-treatment performed at 800 to 950° C. The first heat-treatment may be a heat-treatment for diffusing the second doping material to the inside of the sintered body through the grain boundary diffusion.

In addition, the heat-treatment in the second doping step may include a second heat-treatment performed at a temperature which is relatively lower than that of the first heat-treatment after the first heat-treatment is performed. That is, the heat-treatment in the second doping step may be a multi-step heat-treatment including the first heat-treatment and the second heat-treatment as described above. The second heat-treatment may be a heat-treatment for improving a fine structure of the sintered magnet. Accordingly, the second heat-treatment is preferably performed at 400 to 600° C.

In detail, the heat-treatment in the second doping step may be a multi-step heat-treatment including the first heat-treatment at 800 to 950° C. and the second heat-treatment at 400 to 600° C., and may be performed under vacuum or inert atmosphere. Here, the vacuum atmosphere may be a pressure of 1×10⁻⁴ to 1×10⁻⁷ torr, and the inert atmosphere may be argon, nitrogen, helium or a mixed gas thereof. Time required for the first heat-treatment is enough to sufficiently diffuse and flow the second doping material in the sintered body without decreasing the magnetic characteristic caused by formation of a significantly thick shell on the surface region of the first doped sintered body. As a specific example thereof, the first heat-treatment may be performed for 1 to 3 hours. As a non-limiting example thereof, the second heat-treatment may be performed for 1 to 3 hours.

The present invention provides a sintered magnet fabricated by the fabrication method as described above.

In the sintered magnet according to an exemplary embodiment of the present invention, each of the grains forming the sintered magnet has a core-shell structure including the core of the main phase and the shell enclosing the main phase, and the shell may have an average thickness 0.1 to 0.3 times an average radius (R) of the grain of the core-shell structure.

In addition, in the sintered magnet according to an exemplary embodiment of the present invention, a ratio at which a grain boundary is formed by contact between the cores rather than the shells based on one grain (a grain boundary area formed by contact between the cores/total grain boundary area of one grain*100) may be less than 50, substantially, 0.

Further, in the sintered magnet according to an exemplary embodiment of the present invention, a sum of a (BH) max value and a coercivity (Hc) value in a curve of a magnetic field intensity (H)−a magnetic flux density (B) may be 6.22 to 6.5, wherein the (BH) max value is a maximum value of B times H.

In addition, the coercivity value of the sintered magnet according to an exemplary embodiment of the present invention may be larger by 1.5 to 2 kOe than the reference sintered magnet obtained by performing the doping of step b) on the reference sintered body. Here, the reference sintered body and the reference sintered magnet which is a standard of the coercivity as described above by Relational Formula 1 of the fabrication method may be more specifically defined by Comparative Examples to be described below.

Hereinafter, although Examples having a neodymium-based sintered magnet a target for the fabrication method of the present invention have been disclosed, they are provided for experimentally proving that the fabrication method of the present invention is excellent and for assisting in the entire understanding of the present invention, and therefore, the present invention is not limited to Examples to be described below.

### Example 1

Magnet raw material powder having an average grain of 5 μm was prepared by weighing Nd, Fe, Fe₃B, Cu, Co, Al and Nd so as to satisfy composition of 32 wt % of Nd, 64.56 wt % of Fe, 1 wt % of B and 2.44 wt % of M (M=0.20 wt % of Cu, 1.67 wt % of Co, 0.20 wt % of Al and 0.37 wt % of Nb), followed by mixing, induction melting to fabricate an alloy, strip-casting, and hydrogen processing.

DyF₃ (average size of 1.4 μm) was put into the prepared magnet raw material powder so as to contain 0.5 wt %, 1.0 wt %, 1.5 wt %, 2.0 wt % or 3 wt % of Dy to prepare mixed powder.

After the prepared mixed powder was put into a rectangular parallelepiped-shaped mold made of a tungsten carbide material and uniaxially pressed with 300 Mpa to fabricate a molding body of 15.0 mm (length)×11.0 mm (width)×14.1˜14.5 mm (height).

The fabricated molding body was sintered under vacuum atmosphere (1×10⁻⁵ to 1×10⁻⁷ torr) at 1060° C. for 4 hours to fabricate a first doped sintered body.

The first doped sintered body was impregnated with a doping liquid in which 50M (molar concentration) of DyH₂ is dissolved in absolute alcohol, taken out and dried under vacuum atmosphere (1×10⁻¹ to 1×10⁻³ torr) for 5 minutes, and dried under inert atmosphere for 3 minutes for complete drying, to form a coating layer.

After the sintered body in which the coating layer is formed was subjected to a first heat-treatment under vacuum atmosphere (1×10⁻⁵ to 1×10⁻⁷ torr) at 900° C. for 2 hours, and a second heat-treatment was performed at 500° C. for 2 hours, to fabricate a sintered magnet.

### Example 2

A sintered magnet was fabricated by performing the same method as Example 1 except for using DyH₂ instead of using DyF₃ as the first doping material (the first heavy rare earth compound) in Example 1.

### Example 3

A sintered magnet was fabricated by performing the same method as Example 1 except for using DyF₃ instead of using DyH₂ as the second doping material (the second heavy rare earth compound) forming the coating layer in Example 1 and using a coating liquid in which 50M (molar concentration) of DyF₃ is dissolved in absolute alcohol.

### Example 4

A sintered magnet was fabricated by performing the same method as Example 1 except for using DyH₂ instead of using DyF₃ as the first doping material (the first heavy rare earth compound) in Example 1, using DyF₃ instead of using DyH₂ as the second doping material (the second heavy rare earth compound) forming the coating layer in Example 1, and using a coating liquid in which 50M (molar concentration) of DyF₃ is dissolved in absolute alcohol.

### Comparative Example 1

A reference sintered body was fabricated by forming a molding body without adding DyF₃ as the first doping material in Example 1 and performing a sintering treatment by the same method as Example 1, and a reference sintered magnet was fabricated by forming the coating layer on the fabricated reference sintered body and performing a heat-treatment by the same method as Example 1.

After fabricating magnet raw material powder by the same method as Example 1, a molding body was fabricated by performing the same method as Example 1 without adding the doping material, and the fabricated molding body was sintered under vacuum atmosphere (1×10⁻⁵ to 1×10⁻⁷ torr) at 1060° C. for 4 hours, to fabricate a reference sintered body.

The reference sintered body was impregnated with a doping liquid in which 50M (molar concentration) of DyH₂ is dissolved in absolute alcohol, taken out and dried under vacuum atmosphere (1×10⁻¹ to 1×10⁻³ torr) for 5 minutes, and dried under inert atmosphere for 3 minutes for complete drying, to form a coating layer on a surface of the reference sintered body.

After the reference sintered body in which the coating layer is formed was subjected to a first heat-treatment under vacuum atmosphere (1×10⁻⁵ to 1×10⁻⁷ torr) at 900° C. for 2 hours, and a second heat-treatment was performed at 500° C. for 2 hours, to fabricate a reference sintered magnet.

### Comparative Example 2

A sintered magnet was fabricated by performing the same method as Example 1 except for not adding DyF₃ as the first doping material, using DyF₃ instead of using DyH₂ as the second doping material (the second heavy rare earth compound) forming the coating layer, and using a coating liquid in which 50M (molar concentration) of DyF₃ is dissolved in absolute alcohol.

### Comparative Example 3

Raw material powder was prepared by putting DyF₃ into the mixed powder so as to contain 0.5 to 3.0 wt % of Dy (0.5 wt %, 1.0 wt %, 1.5 wt %, 2.0 wt % or 3 wt % of Dy), and the raw material powder was molded and sintered by the same method as Example 1, to fabricate a sintered magnet. Here, the second doping process which is a doping process by the formation of the coating layer was not performed.

### Comparative Example 4

Raw material powder was prepared by putting DyH₂ into the mixed powder so as to contain 0.5 to 3.0 wt % of Dy (0.5 wt %, 1.0 wt %, 1.5 wt %, 2.0 wt % or 3 wt % of Dy), and the raw material powder was molded and sintered by the same method as Example 1, to fabricate a sintered magnet. Here, the second doping process which is a doping process by the formation of the coating layer was not performed.

### Comparative Example 5

Raw material powder was prepared by putting Dy in the fabrication step of the magnet raw material powder so as to contain 3.0 wt % of Dy, followed by induction melting, and the raw material powder itself without adding separate doping materials was molded and sintered by the same method as Example 1, to fabricate a sintered body. The sintered body was impregnated with a doping liquid in which 50M (molar concentration) of DyH₂ is dissolved in absolute alcohol, taken out and dried under vacuum atmosphere (1×10⁻¹ to 1×10⁻³ torr) for 5 minutes, and dried under inert atmosphere for 3 minutes for complete drying, to form a coating layer on a surface of the sintered body.

After the sintered body in which the coating layer formed was subjected to a first heat-treatment under vacuum atmosphere (1×10⁻⁵ to 1×10⁻⁷ torr) at 900° C. for 2 hours, and a second heat-treatment was performed at 500° C. for 2 hours, to fabricate a sintered magnet was performed.

### Comparative Example 6

Raw material powder was prepared by putting Dy in the fabrication step of the magnet raw material powder so as to contain 3.0 wt % Dy, followed by induction melting, and the raw material powder itself without adding separate doping materials was molded and sintered by the same method as Example 1, to fabricate a sintered body. The sintered body was impregnated with a doping liquid in which 50M (molar concentration) of DyH₃ is dissolved in absolute alcohol, taken out and dried under vacuum atmosphere (1×10⁻¹ to 1×10⁻³ torr) for 5 minutes, and dried under inert atmosphere for 3 minutes for complete drying, to form a coating layer on a surface of the sintered body.

After the sintered body in which the coating layer is formed was subjected to a first heat-treatment under vacuum atmosphere (1×10⁻⁵ to 1×10⁻⁷ torr) at 900° C. for 2 hours, and a second heat-treatment was performed at 500° C. for 2 hours, to fabricate a sintered magnet.

Fine structure analysis and element analysis of the sintered magnets fabricated by the Examples and the Comparative Examples were conducted by an electron probe micro analyzer (EPMA) and wavelength dispersive spectroscopy (WDS). A cross section of the sintered magnet was analyzed and a depth at which Dy was detected up to 1.0 atom % was defined as a diffusion depth. Here, when the first doping step and the second doping step were performed according to an exemplary embodiment of the present invention, the depth at which Dy was detected up to 1.0 atom % by the second doping step was defined as the diffusion depth, based on the reference (0 atom %) being defined as a doping concentration in the first doping step. The magnetic characteristics (B-H curve) of the sintered magnets fabricated by Examples and Comparative Examples were analyzed by using B-H hysteresis loop tracer.

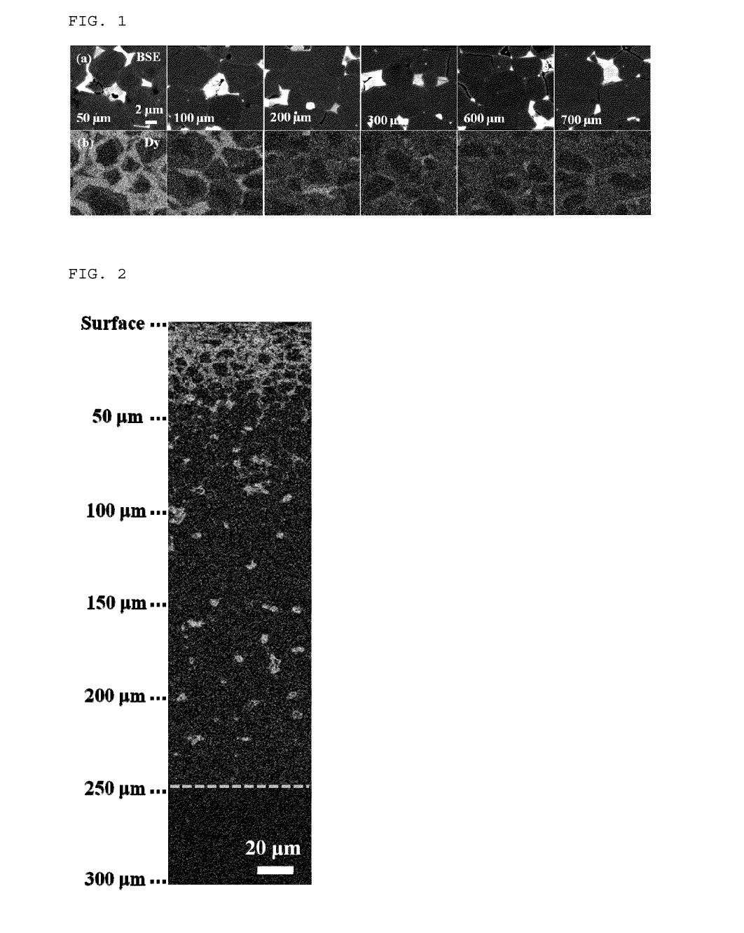

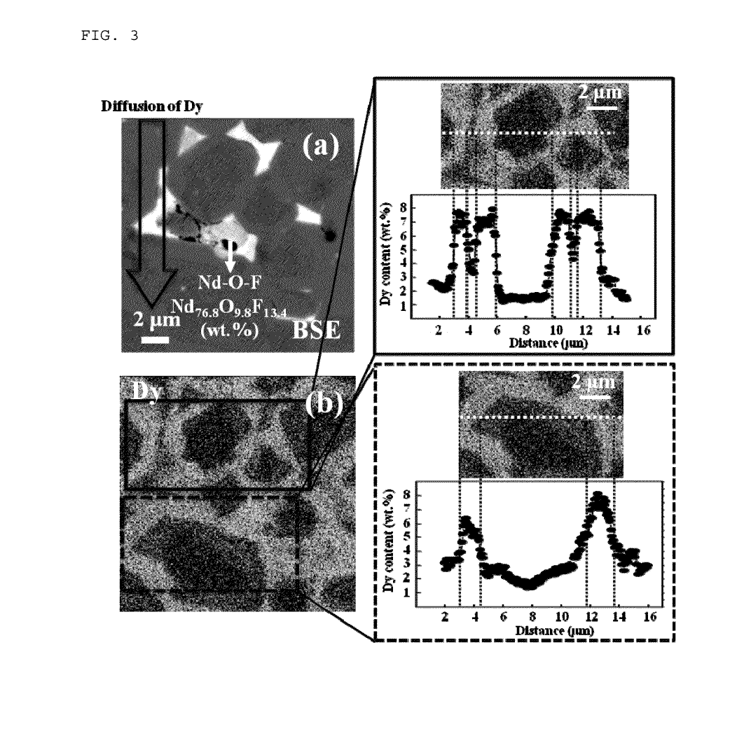

FIG. 1(a) is a scanning electron micrograph image obtained by observing a cross section of the sintered magnet of Example 1 fabricated after the sintered body doped with 1.0 wt % of Dy was fabricated, followed by the second doping treatment and FIG. 1(b) is a view illustrating a mapping result of Dy element concentration of the corresponding cross section, and FIG. 2(a) is a cross section of the reference sintered magnet fabricated by Comparative Example 1.

It could be appreciated from FIG. 1 that when the multi-step doping including the first doping and the second doping was performed according to an exemplary embodiment of the present invention, the diffusion of the doping element was more improved, and the reference sintered magnet fabricated by Comparative Example 1 had a Dy diffusion depth of about 250 μm, and the sintered magnet of Example 1 fabricated after the sintered body doped with 1.0 wt % of Dy was fabricated, followed by the second doping treatment had a Dy diffusion depth of about 700 μm. In addition, it was confirmed from analysis results of diffusion depth of the sintered magnets fabricated by Examples 1 to 4 that the sintered magnet of Example 1 had remarkably large diffusion depth and the sintered magnet fabricated by using DyH₂ in the second doping process had larger diffusion depth.

FIG. 3(a) is a scanning electron micrograph image obtained by observing a fine structure of the sintered magnet of Example 1 fabricated after the sintered body doped with 1.0 wt % of Dy was fabricated, followed by the second doping treatment and FIG. 3(b) is a view illustrating a mapping result of Dy element concentration of the corresponding cross section. It may be appreciated from FIG. 3 that in the sintered magnet according to an exemplary embodiment of the present invention, the shell uniformly and homogeneously doped with Dy in the grain boundary region was formed, that is, a significantly thin and uniform shell entirely enclosing the core of the main phase (Nd₂Fe₁₄B) was formed. As a result obtained by measuring an average radius of the grain (grain in the core-shell structure) and an average thickness of the shell, it was confirmed that the shell had a thickness 0.1 to 0.3 times the average radius (R) of the grain. Further, as a result obtained by an element analysis on a region marked by an arrow in FIG. 3, it was confirmed that a Nd—O—F compound rather than an oxide of Dy was formed, and in addition, it was confirmed that regardless of the compound, the shell having a predetermined thickness was formed around the compound. Similar to FIG. 3, it was confirmed from a result obtained by observing the core-shell structure of the sintered magnets fabricated in Examples 2 to 4 that when the hydride was used in the first doping step, Dy oxide remained in the grain boundary or the triple-point, and the Dy oxide absorbed Dy in the subsequent second doping step to function as a sink, such that the shell was not formed well in a lower portion of the Dy oxide (a lower portion in a direction in which Dy was diffused).

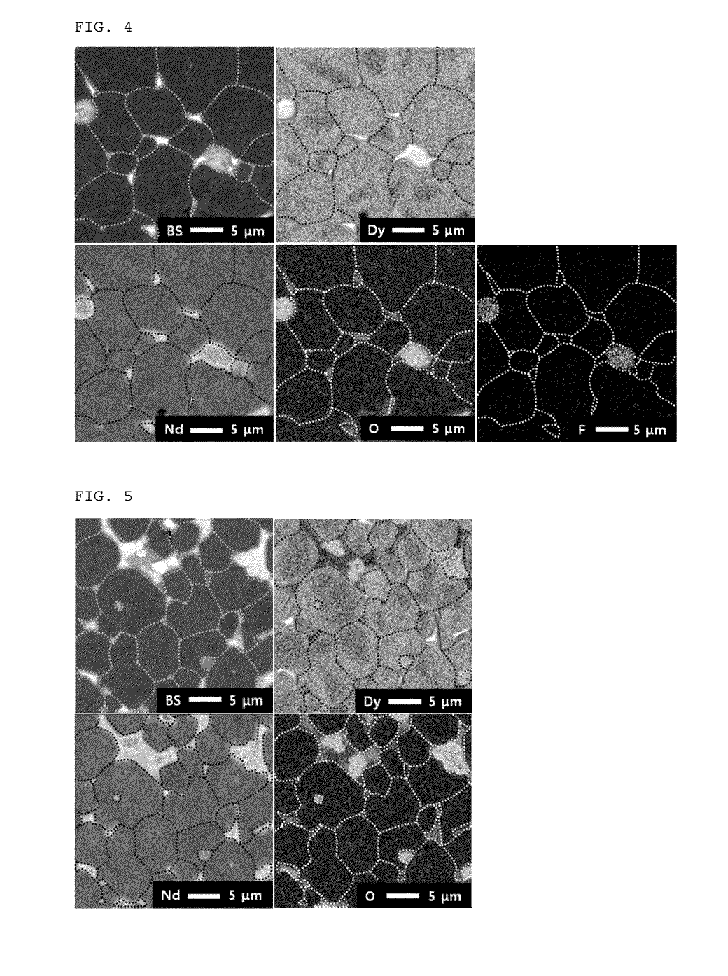

FIG. 4 is a scanning electron micrograph image obtained by observing a fine structure (shown by BS in FIG. 4) of the sintered magnet fabricated by Comparative Example and is a view illustrating a mapping result of each element concentration by energy spectral analysis, wherein Dy, Nd, O or F at the right side of a scale bar in FIG. 4 marks a detection element for image mapping. FIG. 5 is a scanning electron micrograph image obtained by observing a fine structure (shown by BS in FIG. 5) of the sintered magnet fabricated by Comparative Example 4 and is a view illustrating a mapping result of each element concentration by energy spectral analysis, wherein Dy, Nd, or O at the right side of a scale bar in FIG. 5 marks a detection element for image mapping.

It could be appreciated from FIGS. 4 and 5 that when the sintered magnet was fabricated by the first step doping process which is a process of mixing powder, a thick shell was formed, the doping materials condensed and remained in the grain boundary or a triple point, and an oxide was formed. Further, it could be appreciated from FIGS. 4 and 5 that DyF₃ was easily lattice-diffused but not DyH₂ in the main phase, and DyH₂ was diffused by the grain boundary diffusion rather than by the lattice diffusion.

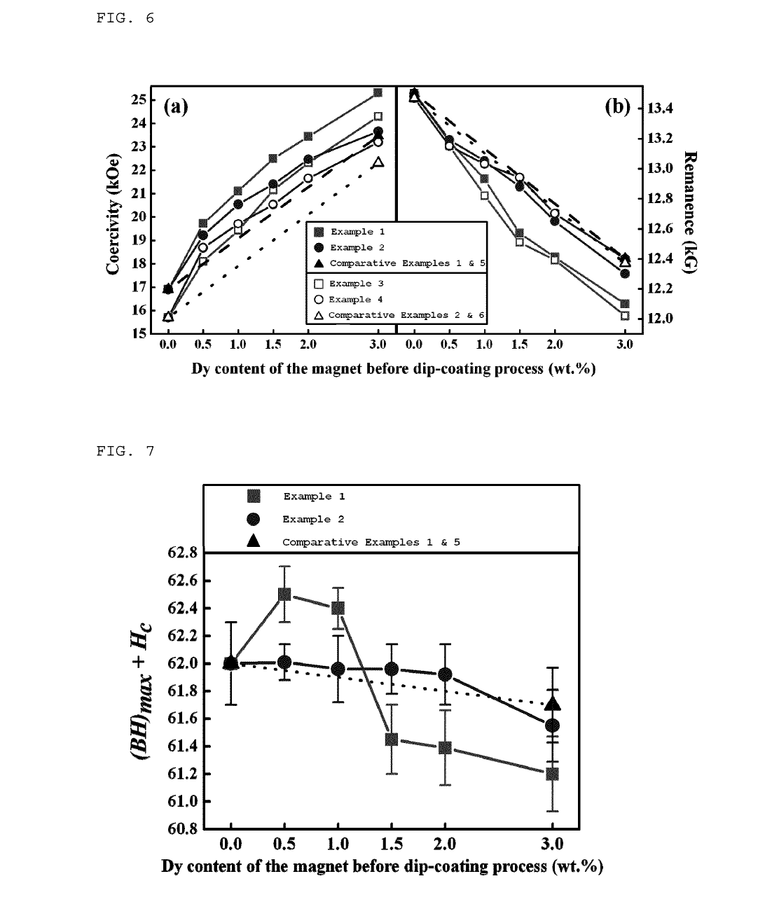

FIG. 6 is a view illustrating results obtained by measuring coercivity (FIG. 6a) and remanence (FIG. 6b) of the sintered magnets fabricated by Examples 1 to 4 and Comparative Examples 1 and 2 and Comparative Examples 5 and 6. It could be appreciated from FIG. 6 that the sintered magnets of the Examples had improved coercivity as compared to Comparative Examples 1 and 2 fabricated only by performing the second doping process which is the grain boundary diffusion step and Comparative Examples 5 and 6 in which the doping was performed in the step of forming an alloy with the magnetic composition. In particular, it could be appreciated that the sintered magnet of Example 1 fabricated by mixing and sintering a small amount of DyF₃ in which the lattice diffusion was mainly generated, as the first doping material, and by forming a coating layer with DyH₂, followed by heat-treatment, had remarkably excellent magnetic characteristic, wherein the sintered magnet of Example 1 had larger coercivity by about 2 kOe than that of the reference sintered magnet of Comparative Example 1 and that of the sintered magnet of Comparative Example 5 using DyH₂ in which the grain boundary diffusion was easier than the lattice diffusion.

FIG. 7 is a view illustrating each permanent magnet performance index (coercivity+magnetic energy; magnetic energy=BxHmax) of the sintered magnets measured for each Dy content (Dy content wt % contained in the raw material powder at the time of fabricating the sintered body) of the sintered body, the sintered magnets being fabricated by Examples 1 (shown by a red square) and 2 (shown by a blue circle) and Comparative Examples 1 and 5 (shown by a black triangle).

It could be appreciated from the results of FIGS. 6 and 7 that in the grain boundary diffusion, at the time of using the hydride in which the grain boundary diffusion was performed easily as compared to the lattice diffusion, the magnetic characteristic was more improved. In addition, it could be appreciated from the results of Examples 1 and 2, and Comparative Examples 1 and 5 that when the sintered body was fabricated by adding a small amount (1.5 wt % or less) of halide in which the lattice diffusion was easily performed, preferably, a fluoride, in the first doping step, followed by a multi-step doping process which is grain boundary diffusion with the hydride, a permanent magnet performance index was capable of being remarkably improved. That is, it could be appreciated that when the sintered body was fabricated by adding the hydride in which the grain boundary diffusion was more easily performed, the permanent magnet performance index was decreased by abnormality such as the heavy rare earth oxide functioning as a sink of the diffused heavy rare earth element. That is, it could be appreciated that the permanent magnet performance index of the sintered magnet of Example 1 in which the halide capable of homogeneously forming a shell having a thin and uniform thickness, preferably, a fluoride added was higher than that of the sintered magnet of Example 2. Specifically, it could be appreciated that the sintered magnet of Example 1 had the most excellent permanent magnet performance index, the sintered magnet being fabricated after the sintered body was fabricated by putting a small amount of heavy rare earth element, that is, DyF₃, so as to contain 1.5 wt % or less, substantially, 0.5 to 1.5 wt %, preferably, 1 wt % or less, substantially, 0.5 to 1 wt % of Dy, followed by the second doping treatment using DyH₂.

Table 1 below shows results obtained by measuring relative density of the sintered bodies fabricated by Example 1 (a sample containing 1.0 wt % of Dy), and Comparative Examples 1 and 4. As shown in Table 1 below, it could be appreciated that the sintered body fabricated by adding DyF₃ had the smallest value of relative density of 97.1%. It could be appreciated that the sintered body fabricated by using the raw material magnetic powder without adding the doping material according to Comparative Example 1 had a relative density of 98.2%, and the sintered magnet (sintered body) of Comparative Example 4 had a relative density of 98.8%.

TABLE 1

| | Sintered Body | | |
|---|---|---|---|
| | of Comparative | Sintered | Sintered Body |
| | Example 1 | Body of | of Comparative |
| | (in a sintered state) | Example 1 | Example 4 |
| Relative | 98.2 | 97.1 | 98.8 |
| Density (%) | | | |

In addition, it was confirmed from the measurement results of density (relative density) of the molding body (green) for fabricating the sintered body that the molding body of Example 1 (sample containing 1.0 wt % of Dy) had a density of 44.7%, and the molding body of Comparative Example 4 had a density of 46.8%.

From the results of the densities of the sintered bodies and the molding bodies, it could be appreciated that DyF₃ serves as a foreign material interrupting rotation of the powder and increasing friction to decrease both of the molding density and the sintering density. It could be appreciated that a diffusion distance of the heavy rare earth element in the grain boundary diffusion step which is the second doping step was additionally increased even by the low sintering density.

In addition, it could be appreciated from results of FIGS. 4 and 5 that DyF₃ had relatively excellent coefficient of lattice diffusion at a sintering temperature as compared to DyH₂. It could be appreciated that when DyF₃ is solid-solutionized in the lattice of the main phase through the lattice diffusion, stress including the lattice distortion was generated in the main phase by relatively large fluorine ion (F⁻, an ionic radius of 1.3 Å), and in addition, the point defects including vacancy defects were increased to alleviate the stress.

It could be appreciated from the Examples and the Comparative Examples as described above that when the first doping material in which the lattice diffusion was easily performed without forming an oxide was mixed and sintered with the magnet raw material powder to fabricate the first doped sintered body, followed by a multi-step doping process which is grain boundary diffusion of the second doping material through the coating layer, the magnetic characteristic, an output, and quality of the sintered magnet were capable of being remarkably improved. In addition, it could be appreciated that when the first doping material is a halide, preferably, a fluoride, and the second doping material is a hydride, the first doped sintered body had low sintering density, stress and point defects were generated by relatively large ionic radii as compared to that of boron (B), the grain boundary diffusion was promoted, and the diffusion depth in the grain boundary diffusion was remarkably increased.

The fabrication method of the rare earth-based sintered magnet according to an exemplary embodiment of the present invention includes a multi-step doping process consisting of the first doping step of mixing and sintering magnet raw material powder and doping material powder and the second doping step of forming a surface coating layer and performing a heat-treatment for diffusion, such that the rare earth-based sintered magnet capable of remarkably decreasing the usage of the heavy rare earth element and having excellent magnetic characteristic in which a permanent magnet performance index is 62 or more may be fabricated.

According to the fabrication method according to an exemplary embodiment of the present invention, the heavy rare earth halide which is easily lattice diffused in the main phase and increases frictional force, preferably, a heavy rare earth fluoride, is used as the first doping material in the first doping step, such that density of the sintered body may be deteriorated and stress and point defects may be generated in the main phase to remarkably improve a diffusion depth in the second doping step, and therefore, the sintered magnet having a bulky thickness of several millimeters (mm) may be fabricated, wherein the sintered magnet to be fabricated may have homogeneous magnetic characteristic.

According to the fabrication method according to an exemplary embodiment of the present invention, a small amount of the heavy rare earth halide which is easily lattice diffused in the main phase and increases frictional force may be used as the first doping material in the first doping step, thereby preventing formation of a heavy rare earth oxide phase functioning as a sink of the heavy rare earth element and promoting grain boundary diffusion of the subsequent second doping step, such that a uniform and thin shell entirely enclosing a core of the main phase may be formed.

Hereinabove, although the present invention is described by specific matters, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scopes and spirit of the invention.

What is claimed is:

1. A fabrication method of a sintered magnet comprising:
a) a first doping step of mixing and sintering a first doping material including a first heavy rare earth compound with a rare earth-based magnet raw material powder to fabricate a first doped sintered body; and
b) a second doping step of forming a coating layer of a second doping material including a second heavy rare earth compound on a surface of the first doped sintered body and performing a heat-treatment to fabricate a second doped sintered body.

2. The fabrication method of claim 1, wherein the second doping step satisfies the following Relational Formula 1 by the first doping step:
L_{dif}⁰≦1.5L_{dif} (Relational Formula 1)
in Relational Formula 1, when performing step b) on a reference sintered body fabricated without mixing the first heavy rare earth compound in step a), L_{dif}⁰ indicates a depth in which the second heavy rare earth compound is diffused in a depth direction perpendicular to a surface of the reference sintered body on which the coating layer is formed, and L_{dif} indicates a depth in which the second heavy rare earth compound is diffused in a depth direction perpendicular to a surface of the first doped sintered body on which the coating layer is formed.

3. The fabrication method of claim 1, wherein the rare earth-based magnet raw material powder contains Nd, B and Fe.

4. The fabrication method of claim 3, wherein an ionic radius of a relative element which is a hetero element bound to a first heavy rare earth element contained in the first heavy rare earth compound is larger than that of boron (B).

5. The fabrication method of claim 1, wherein the sintered body of step a) contains 0.5 to 1.5 wt % of a first heavy rare earth element derived from the first heavy rare earth compound.

6. The fabrication method of claim 1, wherein the first heavy rare earth compound is a halide.

7. The fabrication method of claim 6, wherein the second heavy rare earth compound is a hydride.

8. The fabrication method of claim 1, wherein a first heavy rare earth element of the first heavy rare earth compound and a second heavy rare earth element of the second heavy rare earth compound are each independently one or two or more selected from the group consisting of Dy, Tb, Ho, Sm, Gd, Er, Tm, Yb, Lu and Th.

9. The fabrication method of claim 3, wherein the rare earth-based magnet raw material powder further contains one or two or more metals selected from the group consisting of Cu, Co, Al and Nb.

10. The fabrication method of claim 1, wherein the sintering of step a) is performed at 1000 to 1100° C.

11. The fabrication method of claim 1, wherein the heat-treatment of step b) is a multi-step heat-treatment including a first heat-treatment at 800 to 950° C. and a second heat-treatment at 400 to 600° C.

12. A sintered magnet fabricated by the fabrication method of claim 1.
